(19) United States
(12) Patent Application Publication
(10) Pub. No.: US 2013/0191423 A1
(43) Pub. Date: Jul. 25, 2013

(54) IMAGE FILE PROCESSING APPARATUS AND METHOD

(71) Applicant: Fujitsu Limited, Kawasaki-shi (JP)

(72) Inventor: Hideharu MATSUSHITA, Yokohama (JP)

(21) Appl. No.: 13/686,519

(22) Filed: Nov. 27, 2012

(30) Foreign Application Priority Data
Jan. 24, 2012 (JP) 2012-012155

(51) Int. Cl. G06F 17/30

(52) U.S. Cl. CPC G06F 17/3007
USPC 707/821

(57) ABSTRACT

An image file processing apparatus includes an image generation apparatus that carries out: (a) storing with a table in which identifiers for identifying data representing design values of design elements are associated with data representing design values by each of the design elements of the design object; (b) acquiring image generation data for each of the design elements of the design object based on design data of the design object; and (c) generating image data expressing an image for each of the design elements of the design object based on the image generation data, deriving the identifiers corresponding to design values for the image data based on the table, associating the derived identifiers with the generated image data, and, for each of the design elements of the design object, generating an image file containing the image data and definition data related to the image data.

### CROSS-REFERENCE TO RELATED APPLICATION

This application is based upon and claims the benefit of priority of the prior Japanese Patent Application No. 2012-012155, filed on Jan. 24, 2012, the entire contents of which are incorporated herein by reference.

### FIELD

The embodiments discussed herein are related to an image file processing apparatus and an image file processing method.

### BACKGROUND

Currently, graphic processing systems such as computer aided design (CAD) systems are employed in the design of circuit boards such as printed circuit boards. Sometimes drawing data of a graphic processing system is also employed during circuit board manufacture. Sometimes drawing data for previously designed circuit boards is reused when a previously designed circuit board is improved or a portion of a previously designed circuit board is appropriated in the design of a new circuit board.

However, when a graphic processing system is employed to design a circuit board, in some cases design is distributed across plural locations to shorten design duration and improve efficiencies. When design is distributed across plural locations, then design execution portions arise from the differences between the drawing data before and after design has been executed in each of the plural locations. Accordingly for example confirmation as to whether or not requirements and instructions have been accurately incorporated in design drawings as the design proceeds can be accomplished by extracting and outputting differences in the drawing data after design to the drawing data prior to starting design.

However, generally graphic processing systems are constructed according to their own unique internal specifications, and it is difficult to utilize drawing data generated on a given graphic processing system on a separate graphic processing system of different internal specification. When employing different graphic processing systems of different internal specifications at plural locations, if the graphic processing system that generated drawing data prior to starting the design and the graphic processing system that generated the drawing data at design completion have different internal specifications then it is difficult to extract points of difference from the drawing data.

There are a number of known technologies for extracting points of difference in circuit board drawing data. For example, a known technique for displaying differences is to overlay images of drawing data generated on different CAD systems. There is also a known technique in which manufacturing data for a circuit board is appended with image data of check manufacturing data, and the validity of manufacturing data checked using such image data. Another known technique is to perform analysis by comparing a first raster drawing of drawing data of a first CAD system with a second raster drawing generated by converting drawing data of the first CAD system into the data format of the second CAD system. Another known technique is to compare layout data and image data before and after correction, and derive and display differences therebetween.

### RELATED PATENT DOCUMENT

Japanese Laid-Open Patent Publication No. 10-269259
Japanese Laid-Open Patent Publication No. 11-272739
Japanese Laid-Open Patent Publication No. 2007-52469
Japanese Laid-Open Patent Publication No. 10-21418

### SUMMARY

According to an aspect of the embodiments, an image file processing apparatus includes an image file generation apparatus. The image file generation apparatus includes: a first processor; and a first memory storing instructions, which when executed by the first processor to perform a first procedure. The first procedure includes: (a) storing, in the first memory, with a table in which identifiers for identifying data representing design values of design elements are associated with data representing design values of design elements of a design object by each of the design elements of the design object; (b) acquiring image generation data for each of the design elements of the design object based on design data of the design object containing design values of the respective design elements; and (c) generating image data expressing an image for each of the design elements of the design object based on image generation data acquired at (b), deriving the identifiers corresponding to design values of the design elements for the generated image data based on the table stored in the first memory, associating the derived identifiers with the generated image data, and, for each of the design elements of the design object, generating an image file containing the image data and definition data related to the image data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating a schematic configuration of an image file system according to an exemplary embodiment;

FIG. 2 is a schematic block diagram of an image file generation apparatus according to the present exemplary embodiment;

FIG. 3 is a schematic block diagram of an image file analysis apparatus according to the present exemplary embodiment;

FIG. 4 is an image illustrating an example of a data pallet definition table;

FIG. 5 is an image illustrating an example of an image file structure;

FIG. 6 is an image illustrating an example of a procedure for generating a CAD image file;

FIG. 7 is a flowchart illustrating an example of a processing flow in image file generation;

FIG. 8 is a flowchart illustrating an example of a pre-processing flow;

FIG. 9A is a plan view for explaining vias;

FIG. 9B is a diagram illustrating a stacking direction (stacking layers) for explaining the vias;

FIG. 10A is a plain view for explaining component height;

FIG. 10B is a diagram illustrating a stacking direction (stacking layers) for explaining the component height; and

FIG. 11 is a flowchart illustrating a processing flow in image file analysis.

### DESCRIPTION OF EMBODIMENTS

Preferred embodiments of technology disclosed herein will be explained in detail with reference to accompanying drawings.

[Image File Generation Apparatus]

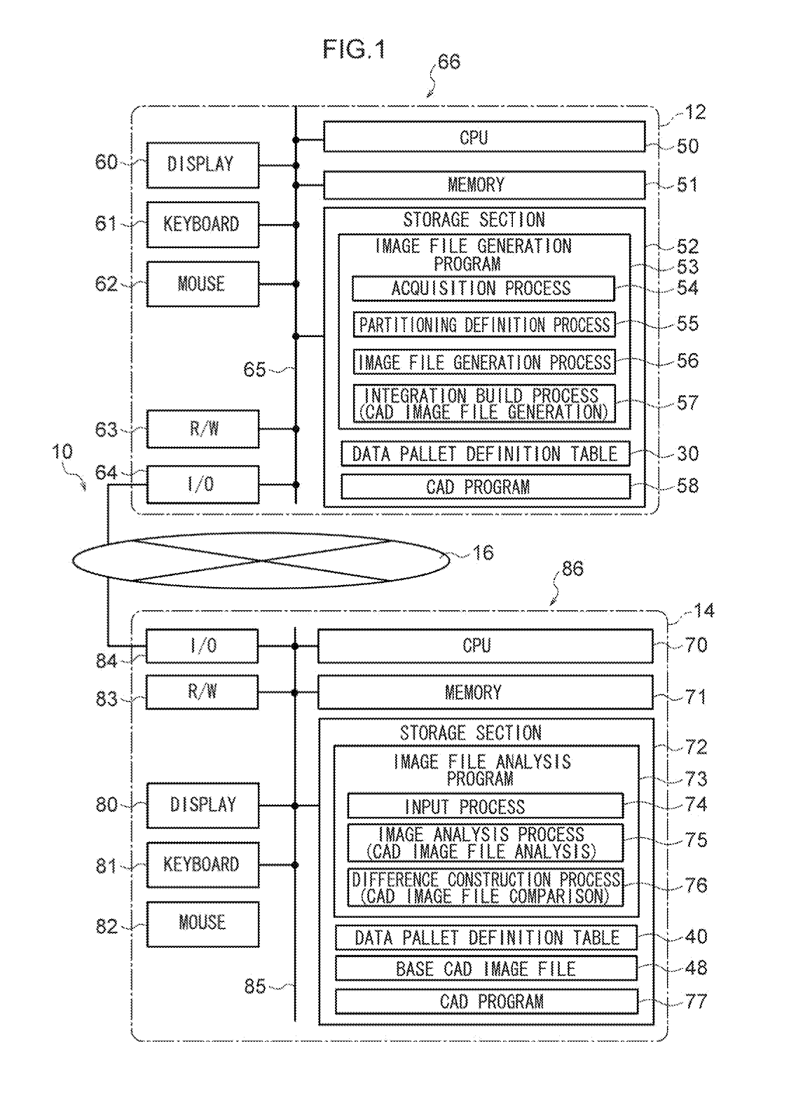

FIG. 1 is a diagram illustrating an image file system 10. The image file system 10 includes an image file generation apparatus 12 according to the present exemplary embodiment implemented, for example, by a computer 66, and an image file analysis apparatus 14 according to the present exemplary embodiment implemented, for example, by a computer 86. The image file system 10 is connected to a computer network 16 such as the Internet. The image file generation apparatus 12 and the image file analysis apparatus 14 are connected together through the computer network 16 so as to be capable of exchanging data with each other. Details regarding the image file generation apparatus 12 and the image file analysis apparatus 14 follow.

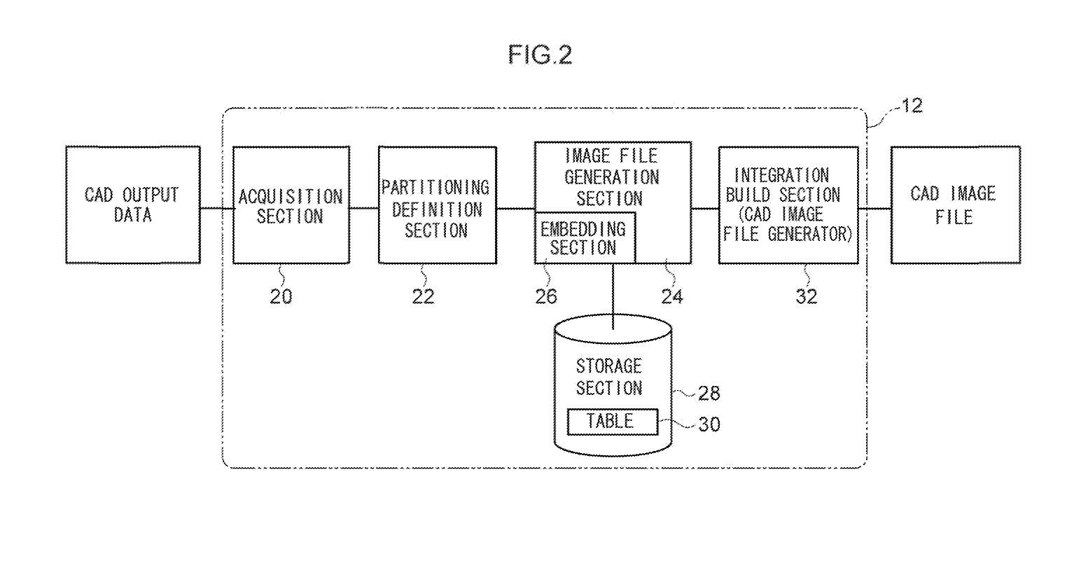

FIG. 2 illustrates the image file generation apparatus 12 according to the present exemplary embodiment. The image file generation apparatus 12 performs processing to generate an image file based on image file output data that has been output by a graphic processing system such as a CAD system, not illustrated in the drawings, when employed to design a circuit board such as a printed circuit board as a design object. The image file generation apparatus 12 includes an acquisition section 20, a partitioning definition section 22, an image file generation section 24, and an integration build section 32. The image file generation section 24 is provided with an embedding section 26. The image file generation section 24 is also provided with a storage section 28 that stores a data pallet definition table 30.

The image file generation apparatus 12 may, for example, be implemented by the computer 66 illustrated in FIG. 1. The computer 66 includes a CPU 50, a memory 51, a nonvolatile generation-side storage section 52, a keyboard 61, a mouse 62, and a display 60, mutually connected together through a bus 65. In the computer 66, an interface (I/O) 64 for connecting to the computer network 16 and an R/W device 63 into which a storage medium is inserted to read and write to the storage medium are connected to the bus 65. Note that the storage section 52 may be implemented for example by a Hard Disk Drive (HDD) or flash memory. The storage section 52 is stored with an image file generation program that causes the computer 66 to function as the image file generation apparatus 12. The storage section 52 is also stored with the data pallet definition table 30. A CAD program 58 is also stored on the storage section 52, the program causing the computer 66 to function as a graphic processing system such as a CAD system when employing the computer 66 to design a circuit board such as a printed circuit board. The CPU 50 reads out an image file generation program 53 from the storage section 52, expands the image file generation program 53 into the memory 51 and sequentially executes the processes of the image file generation program 53.

In the present exemplary embodiment an example is given in which the image file generation apparatus 12 is connectable to the computer network 16, however the image file generation apparatus 12 is not limited to being connectable to the computer network 16. In other words, an example of the image file generation apparatus 12 of the technology disclosed herein may be configured capable of execution by the image file generation apparatus 12 alone. In such cases, data such as CAD image files contained on a storage medium that is read from and written to by the R/W device 63 may be utilized.

The image file generation program 53 includes an acquisition process 54, a partitioning definition process 55, an image file generation process 56 and an integration build process 57. The CPU 50 is operated as the acquisition section 20 illustrated in FIG. 2 by executing the acquisition process 54. The image file generation apparatus 12 is implemented by the computer 66, and the computer 66 is operated as the acquisition section 20 by executing the acquisition process 54. The CPU 50 is also operated as the partitioning definition section 22 illustrated in FIG. 2 by executing the partitioning definition process 55. The CPU 50 is operated as the image file generation section 24 illustrated in FIG. 2 by executing the image file generation process 56. The CPU 50 is operated as the integration build section 32 illustrated in FIG. 2 by executing the integration build process 57. The image file generation apparatus 12 is implemented by the computer 66 and the computer 66 is operated as the image file generation section 24 by executing the image file generation process 56. The storage section 52 that stores the data pallet definition table 30 is employed as the storage section 28 in cases in which the image file generation section 24 is implemented by the computer 66.

The image file generation program 53 is an example of an image file generation program of the technology disclosed herein. Namely, the image file generation program 53 is an example of an image file generation program that causes the computer 66 to function as the image file generation apparatus 12. The image file generation program 53 may also be added to the CAD program 58 as a function of the CAD program 58 (called add-in software).

When designing a circuit board such as a printed circuit board, the acquisition section 20 of the image file generation apparatus 12 acquires CAD output data for generated image data output use by the CAD program 58 by causing the computer 66 to function as a CAD system. The CAD output data are data recognizable by a CAD system, and are also data capable of generating image data expressing images of image output elements (an example of design elements). As an example of CAD output data, for a multi-layered circuit board, image output data are respective logic layers configured with image output elements (an example of design elements) included in each of the respective layers. Image output elements are elements such as lines, surface patterning and lands. Sometimes image output elements such as lines, surface patterning and lands are included in the data representing lines in CAD output data. The image output elements also include vias expressing interlayer connections in multi-layered circuit boards. The image output elements also include component shapes expressing profiles and heights of components for mounting to a circuit board. Sometimes the component shapes of image output elements are contained in data representing the surface placement in CAD output data. The image output elements also include a board contour expressing the thickness and external profile of the circuit board. The image output elements also include regions in the layers of the circuit board representing prohibited regions where, for example, wiring lines are prohibited or allowable regions where layout is allowed. The physical layer for each layer is arrived at by stacking logic layers for each of the image output elements for each layer of multiple layers.

The acquisition section 20 is able to obtain the data for each image output element by acquiring CAD output data. Namely, CAD output data contains image data for each of the image output elements and also includes data such as the plan profile and stacking direction (stacking layers) that has been associated with the image data for each of the image output elements, and includes logical data representing line prohibition and allowance. In the following explanation the data such as the plan profile and stacking direction (stacking layers) that has been associated with the image data for each of the image output elements and the logical data representing line prohibition and allowance is sometimes referred to collectively as attribute data that is associated with the image data for each of the image output elements.

The partitioning definition section 22 of the image file generation apparatus 12 employs CAD output data acquired with the acquisition section 20 to define partitioning of the image, as described later. The partitioning definition section 22 performs definition for partitioning an image by taking the minimum size of image output elements in the circuit board (for example the internal diameter of a via) as the size of a single unit and defining 1 pixel for partitioning as the single unit size.

The image file generation section 24 of the image file generation apparatus 12 generates an image file with 1 pixel as the minimum unit as defined by the partitioning definition section 22. Namely, the image file generation section 24 generates an image file containing image data and definition data related to the image data from the data for each image output element in CAD output data. More precisely, an embedding section 26 of the image file generation section 24 derives a pallet number (identifier) for matching to data pallet contents corresponding to image elements stored in the data pallet definition table 30 of the storage section 28, and embeds the pallet number (identifier) in the definition data.

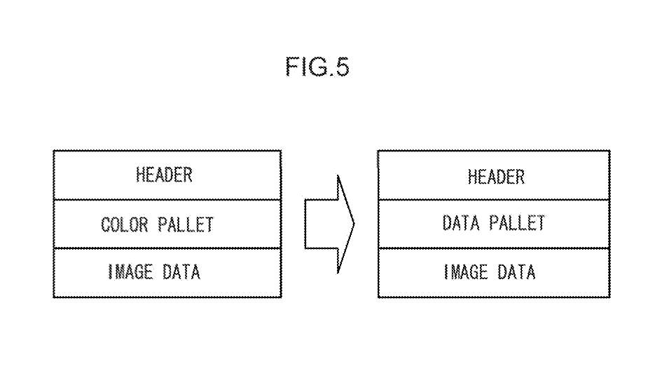

Explanation follows regarding an image file containing a header region, a color pallet region and an image data region, as an example of an image file structure in the present exemplary embodiment. The header region is a region for storing general data employed for plotting the image from the image file. The image data region is a region for storing the actual image (image data) for each of the single pixels (1 pixel). The color pallet region is a region for storing color definition data corresponding to each pixel in the image data region. In the present exemplary embodiment, the data stored in the color pallet region is referred to as definition data. Namely, the embedding section 26 of the image file generation section 24 embeds a pallet number (identifier) (see also FIG. 5), for matching to contents of a data pallet corresponding to image elements stored in the data pallet definition table 30 of the storage section 28, in the color pallet region in place of the color definition data. Note that the image file structure is not limited to an image file containing a header region, a color pallet region and an image data region (FIG. 5). For example, the present exemplary embodiment is applicable to any image files containing a color pallet region.

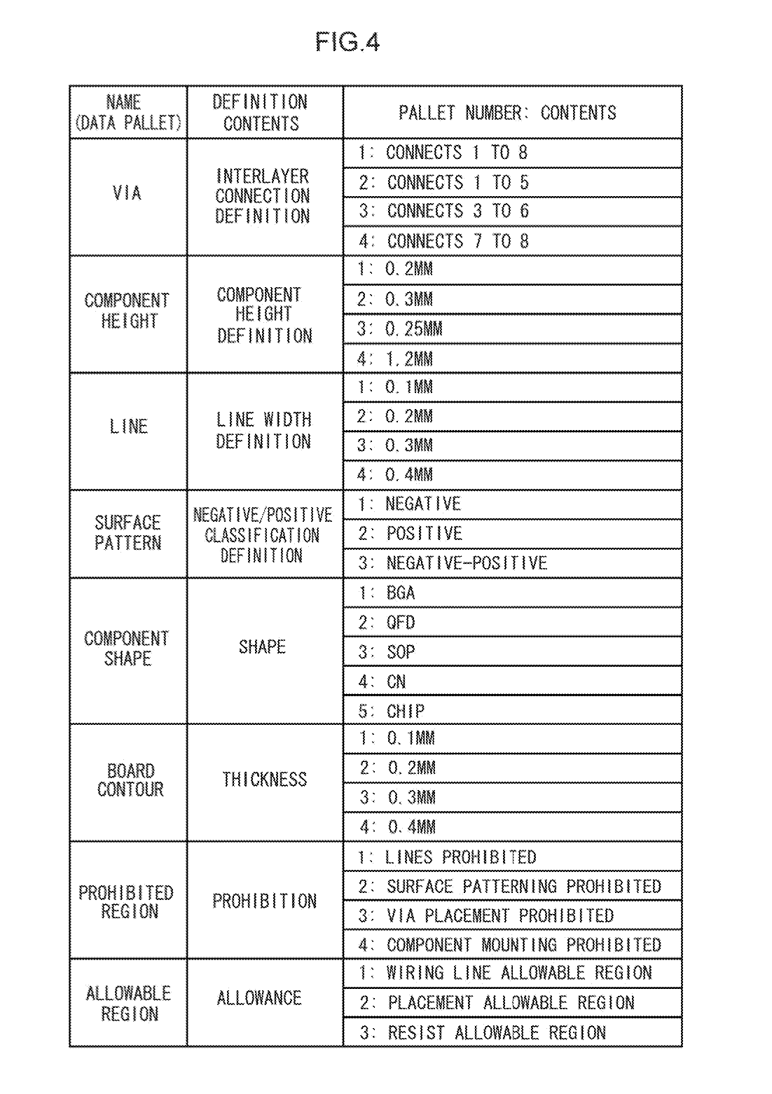

The data pallet definition table 30 stores, as illustrated for example in FIG. 4, with data for “pallet number” and “contents” associated with each “data pallet”. The data for “name (data pallet)” in the data pallet definition table illustrated in FIG. 4 is data representing image output elements (an example of design elements) and data of “definition contents” explains the data pallet. Plural data of “contents” associated with data of “pallet number” are stored in a single data pallet. The data of “contents” that are associated with the data of “pallet number” correspond examples of design values of design elements in a design object. For example, in the data pallet in FIG. 4, associated with “VIA” are: a pallet number “1” with contents “connect 1 to 8”; a pallet number “2” with contents “connect 1 to 5”; a pallet number “3” with contents “connect 3 to 6”; and a pallet number “4” with contents “connect 7 to 8”. Note that the “definition contents” data do not configure the data pallet. FIG. 4 illustrates only a portion of a data pallet definition table, and there is no limitation to the correspondence relationships in the data pallet definition table 30 illustrated in FIG. 4.

Note that in the present exemplary embodiment, explanation follows regarding an embodiment in which the data pallet definition table 30 has been pre-stored in the storage section 28. However, for example, the data pallet definition table 30 may be received by communication with an external data processing apparatus and stored in the memory 51. The data pallet definition table 30 is also not limited to being stored as one on either the storage section 28 or the memory 51. For example, the data pallet definition table 30 may be split into individual data pallets and stored in storage sections, or stored distributed on a computer network such as the Internet.

The integration build section 32 of the image file generation apparatus 12 sorts image files for each image element generated by the image file generation section 24 into each layer, and builds an integrated CAD image file of the plural layers contained in the circuit board. The integration build section 32 functions as an example of an integration build section in the technology disclosed herein. Namely, the integration build section 32 integrates together the image files for each of the image elements generated by the image file generation section 24, and generates an image file of a circuit board. The integration build section 32 is capable of storing generated CAD image files on the memory 51, and transmitting the CAD image files to another computer through the computer network 16 using the I/O 64. The CAD image files may also be stored on a storage medium using the R/W 63.

[Image File Analysis Apparatus]

Explanation follows regarding the image file analysis apparatus 14 according to the present exemplary embodiment.

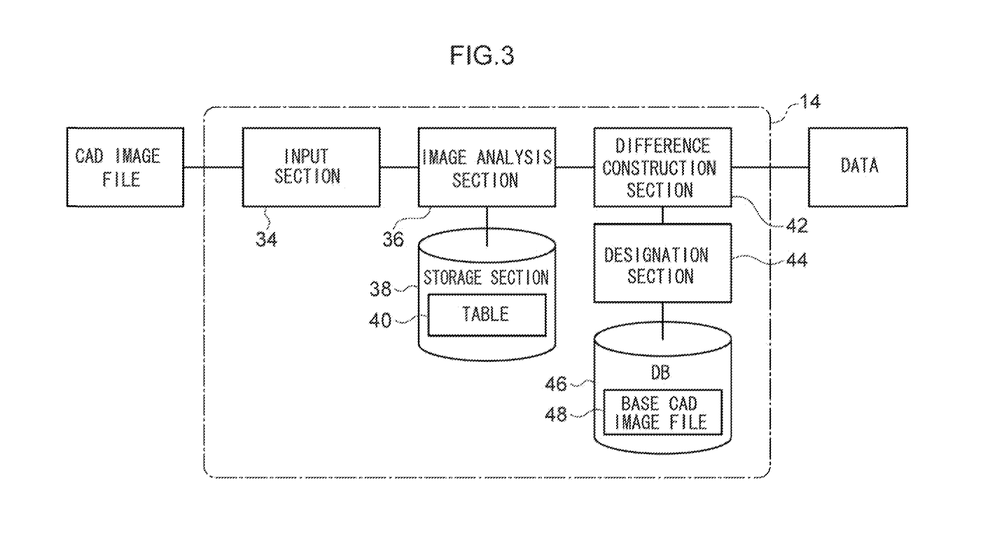

FIG. 3 illustrates the image file analysis apparatus 14 according to the present exemplary embodiment. The image file analysis apparatus 14 performs processing to analyze image files containing CAD image file physical layer and logic layer images based on CAD image files that are output by a graphic processing system such as a CAD system, generated for example by the image file generation apparatus 12. The image file analysis apparatus 14 is equipped with an input section 34 and an image analysis section 36. The image analysis section 36 is connected to a storage section 38 that stores a data pallet definition table 40. The image file analysis apparatus 14 may be equipped with a difference construction section 42. The difference construction section 42 is input with analysis result data from the image analysis section 36 and is input with a base CAD image file designated by a designation section 44 out of base CAD image files stored in a database 46.

The image file analysis apparatus 14 may, for example, be implemented by the computer 86 illustrated in FIG. 1. The computer 86 includes a CPU 70, a memory 71, a nonvolatile analysis-side storage section 72, a keyboard 81, a mouse 82, and a display 80, with these mutually connected through a bus 85. In the computer 86, an interface (I/O) 84 for connecting to the computer network 16 and an R/W device 83 into which a storage medium is inserted to read and write to the storage medium are connected to the bus 85. Note that the storage section 72 may be implemented for example by a Hard Disk Drive (HDD) or flash memory. The storage section 72 is stored with an image file analysis program 73 for causing the computer 86 to function as the image file analysis apparatus 14. The storage section 72 is stored with the data pallet definition table 40 similar to the data pallet definition table 30. Single or plural base CAD image files 48 that are the basis for CAD image file comparison to derive differences are stored in the storage section 72. The storage section 72 is also stored with a CAD program 77 for causing the computer 86 to function as a graphic processing system such as a CAD system when executing design of circuit boards such as printed circuit boards. The CPU 70 reads the image file analysis program 73 from the storage section 72, expands the image file analysis program 73 in the memory 71, and executes the processes of the image file analysis program 73 in sequence.

Note that in the present exemplary embodiment an example is given in which the image file analysis apparatus 14 is connectable to the computer network 16, however there is no limitation to the image file analysis apparatus 14 being connectable to the computer network 16. Namely, an example of the image file analysis apparatus of technology disclosed herein may be executed by the computer 86 alone. In such cases, data may be utilized such as CAD image files contained on a storage medium read and written by the R/W 83.

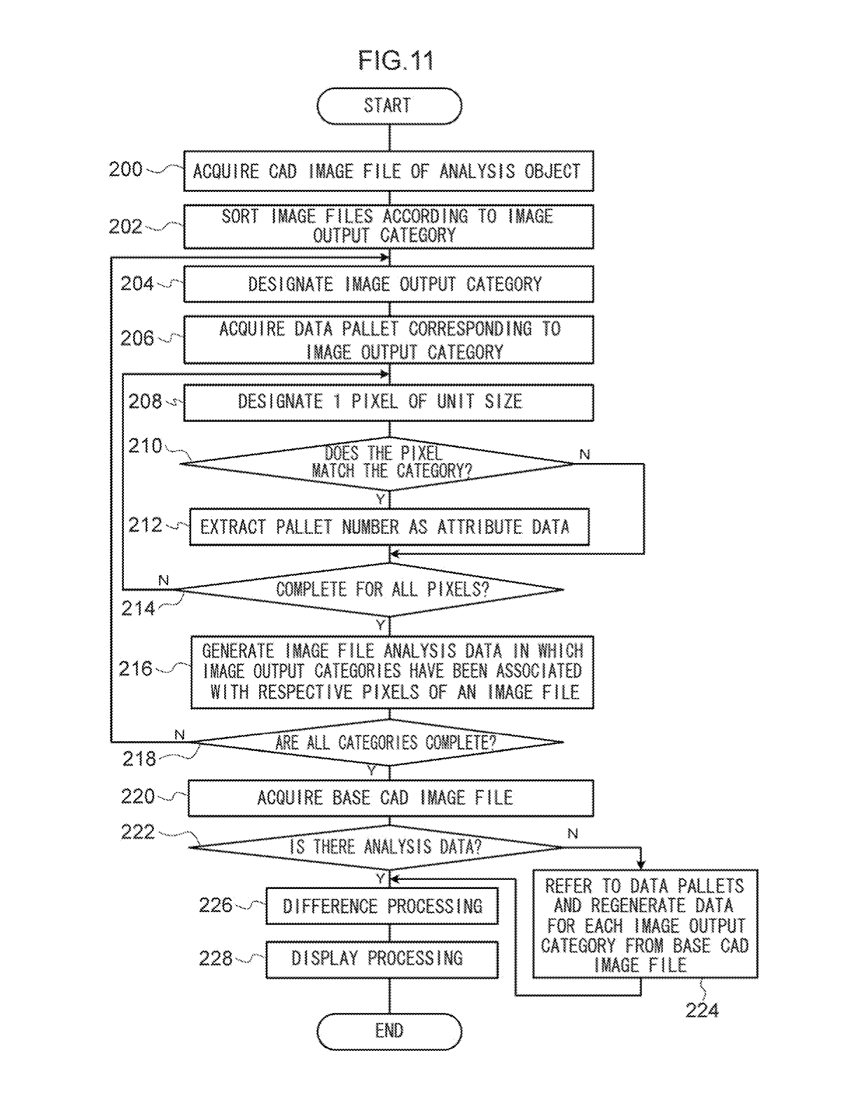

The image file analysis program 73 contains an input process 74, an image analysis process 75 and a difference construction process 76. The CPU 70 operates as the input section 34 illustrated in FIG. 3 by executing the input process 74. The CPU 70 operates as the image analysis section 36 illustrated in FIG. 3 by executing the image analysis process 75. The CPU 70 operates as the difference construction section 42 illustrated in FIG. 3 by executing the difference construction process 76. The CPU 70 operates as the designation section 44 illustrated in FIG. 3 by executing processing (step 220 of FIG. 11) in the difference construction process 76. The image file analysis apparatus 14 is implemented by the computer 86, and the computer 86 operates as the image file analysis apparatus 14 by executing the image file analysis program 73. The storage section 72 storing the data pallet definition table 40 is employed as the storage section 38 when the image analysis section 36 is implemented by the computer 86.

Note that the image file analysis program 73 is an example of an image file analysis program of technology disclosed herein. Namely, the image file analysis program 73 is an example of an image file analysis program for causing the computer 86 to function as the image file analysis apparatus 14. The image file analysis program 73 may be added to a CAD program 77 as one of the functions of the CAD program 77 (called add-in software).

The input section 34 of the image file analysis apparatus 14 is input with a CAD image file that has been generated by the image file generation apparatus 12. The CAD image file is, as described above, data in which image files for each of the image elements have been sorted for each of the layers and is data in which plural layers contained in the circuit board have been integrated. Namely, the CAD image file contains image files of the image output elements (elements representing such items as lines, surface patterning, lands, vias, component shapes, board contour, prohibited regions and allowable regions) by logic layer for each of the layers (physical layers). Consequently the input section 34 is able to obtain an image file for each of the image output elements by being input with the CAD image file.

The image analysis section 36 of the image file analysis apparatus 14 employs a CAD image file that has been imported by the input section 34, and performs analysis as follows. First the image analysis section 36 sorts the image files for each of the layers of the circuit board contained in the CAD image file. Namely, the image analysis section 36 sorts the image files by each of the logic layers in each layer (physical layer), namely by the image output elements. Then, for the image files for each of the image output elements, the image analysis section 36 then extracts definition data related to image data that has been embedded in the image files. The extracted definition data is pallet numbers (identifiers) in the data pallets respectively corresponding to the image output elements. The image analysis section 36 extracts the contents for the pallet numbers by reference to the data pallet in the data pallet definition table 40 in the storage section 38. The extracted contents for the pallet number is attribute data that has been associated with the image data of the image output elements. The image analysis section 36 converts the attribute data associated with the image data of the image files of the image output elements into, for example, text data. The image analysis section 36 generates image file analysis data containing image files and text data, and stores the image file analysis data in a memory. The image file analysis data is generated for all the image output elements and for each layer and stored in the memory. Analysis of the input CAD image file is thereby completed. The attribute data associated with the image data is thus extracted from the CAD image file as, for example, text data. Data such as the plan view profile and stacking direction (stacking layers) associated with the image data for each of the image output elements, and logical data representing line prohibition and allowance, is accordingly capable of being handled as text data, for example.

The difference construction section 42 of the image file analysis apparatus 14 derives differences between the CAD image file analyzed by the image analysis section 36 and the base CAD image file 48 stored in the database 46 designated by the designation section 44. Hence, in the difference construction section 42, differences can be readily derived by comparing the text data of the CAD image files analyzed by the image analysis section 36 with the text data of the base CAD image file 48. The difference construction section 42 takes data representing differences for each of the image output elements and constructs difference data associated with each layer of the circuit board.

Note that in the present exemplary embodiment an embodiment is explained in which the data pallet definition table 40 has been pre-stored in the storage section 38. However, the data pallet definition table 40 may be configured, for example, to be received by communication from an external data processing apparatus and stored on the memory 71. The data pallet definition table 40 is not limited to be being stored as one on the storage section 38 or the memory 71. For example, the data pallet definition table 40 may be split by individual data pallets and stored in storage sections, or may be stored distributed over a computer network such as the Internet.

Explanation follows regarding operation of the present exemplary embodiment.

For example, in order to enable design to be performed at plural locations to reduce the burden and reduce the time for design, construction is desired of an environment enabling design to be performed irrespective of CAD systems employed with different internal specifications. In order to perform design irrespective of CAD systems with different internal specifications the number of processes to verify and correct changed points in the design data needs to be suppressed to a minimum. There is therefore the desire to extract differences to enable confirmation of changed points and corrected points in circuit board data irrespective of CAD systems with different internal specifications.

With this in mind, the present exemplary embodiment provides the data pallet definition tables 30 and 40. In the present exemplary embodiment, as explained in the following, CAD image files are generated with attribute data associated with image data embedded in image files output from the CAD program 58. It is thereby easy to confirm the changed points and corrected points in a circuit board generated by a CAD program by analyzing the generated CAD image files.

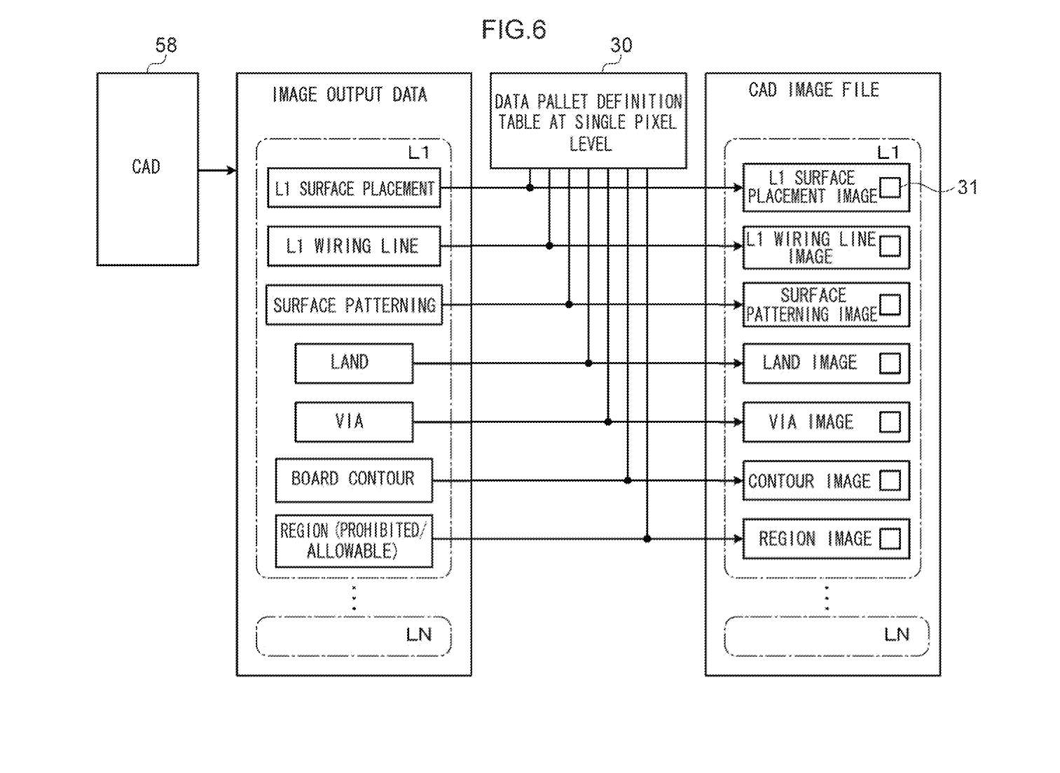

Explanation first follows regarding an outline of image file generation processing executed by the image file generation apparatus 12, with reference to FIG. 6. FIG. 6 is a diagram illustrating an example of a procedure for generating a CAD image file based on CAD output data that has been output by the CAD program 58. In the example given in FIG. 6, a first layer L1 to an N^{th} layer LN are illustrated as CAD output data (image output data) output by the CAD program 58 for a circuit board stacked with N layers. The first layer L1 represents the first logic layer and the logic layer includes an image file for each of the image output elements.

The first layer L1 includes an image file of each of image output elements of L1 surface placement, L1 wiring lines, board contour, and regions. The image output elements of surface pattern, land and VIA are included in the image output element L1 wiring lines. The acquisition section 20 acquires the CAD output data output from the CAD program 58, and the partitioning definition section 22 defines the size of for example the diameter of a via as a single unit, and defines image partitioning with 1 pixel at the unit size. The image file generation section 24 generates CAD image files in which identifiers 31 representing pallet numbers in the data pallet definition table 30 are embedded in color pallet regions at single pixel units, based on attribute data contained in the CAD output data. The CAD image files are accordingly capable of handling data including attribute data associated with image data, namely plan view profiles and stacking direction (stacking layers) associated with image data for each of the image output elements, and logical data representing such factors as line prohibition and allowance.

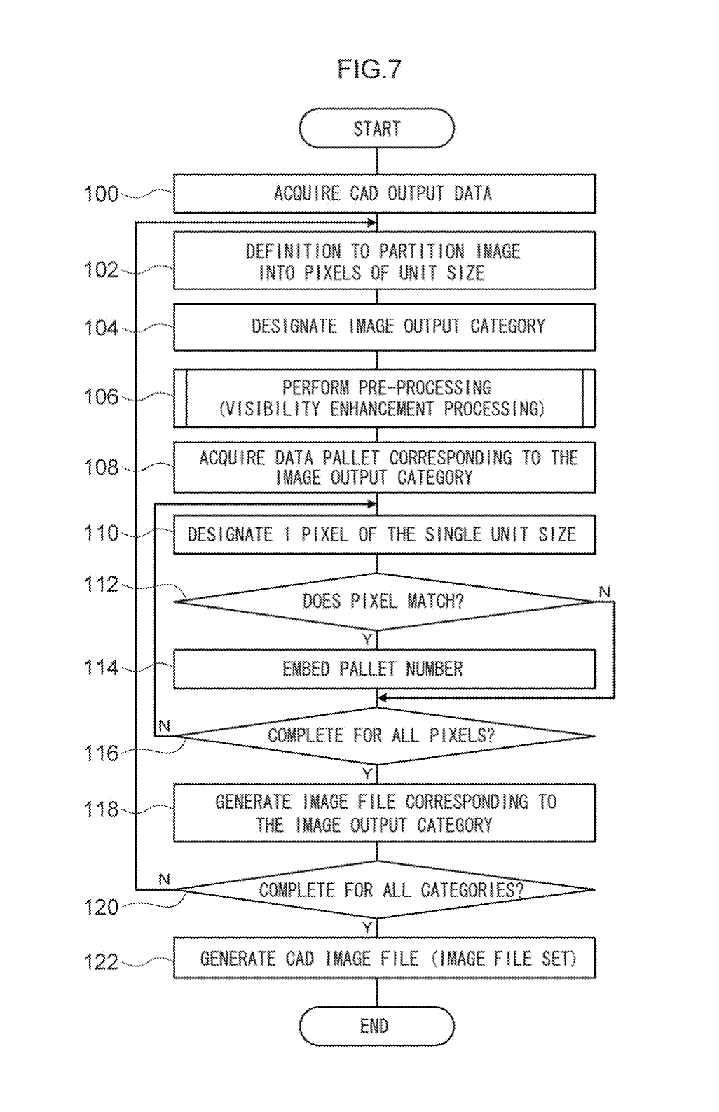

An outline of the image file generation processing has been given above, and explanation follows regarding details of the image file generation processing, with reference to FIG. 7 to FIG. 10.

The processing routine illustrated in FIG. 7 is executed in the image file generation processing. At step 100 CAD output data of the image file generation object designated by a designer is acquired. Namely, CAD output data is acquired by the acquisition section 20 of the image file generation apparatus 12. Then at step 102 the partitioning definition section 22 performs definition to partition the images in the CAD output data acquired by the acquisition section 20 into unit size pixels. Namely, the partitioning definition section 22 defines the minimum size of image output element in the circuit board as the size of a single unit and defines partitioning of images into pixels of the single unit size. Note that when the CAD output data acquired by the acquisition section 20 is image data in which single pixels are already at the single unit size of the minimum size of the image output elements of the circuit board (for example the diameter of a via) then the processing of step 102 is unnecessary.

Next, at step 104 the partitioning definition section 22 designates a category of image output of the CAD output data acquired by the acquisition section 20. Namely, for a circuit board stacked with N layers, the partitioning definition section 22 sequentially designates one layer out of the first layer L1 to the N^{th} layer LN (starting at the first layer L1) for sorting into physical layers of each of the layers included in the CAD output data that has been output from the CAD program 58. The designated logic layers (firstly the image output elements included in the first physical layer) are then output in sequence.

Then the image file generation section 24 performs pre-processing in step 106 on the image data for visibility enhancement of the images. The pre-processing of the image data is executed for the image file of the image output elements of the image output category designated at step 104, on images with image data in which single pixels are of the single unit size defined at step 102. Note that the pre-processing of step 106 is optional processing, and configuration may be made skipping the processing of step 106.

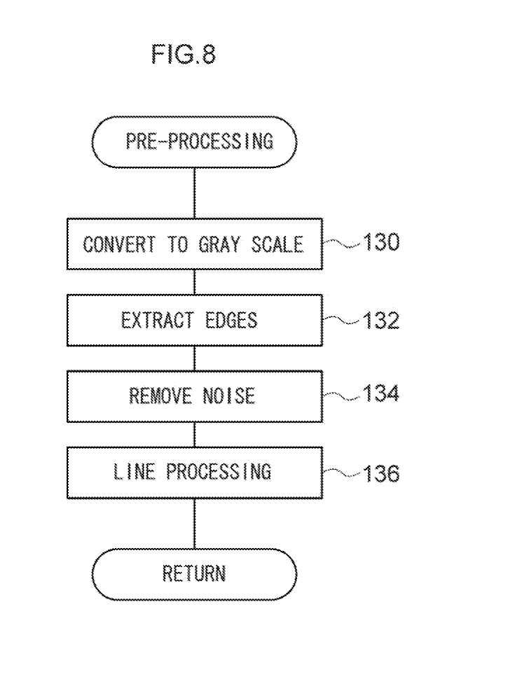

In the pre-processing of step 106 the processing routine illustrated in FIG. 8 is executed. Processing is executed for gray scale conversion at step 130 of FIG. 8. The gray scale conversion processing is processing that leaves only brightness (density) data for a color image. For example the gray scale conversion processing is processing to set a 256 gradation, namely an 8-bit, value for single pixels. Then at step 132 edge extraction processing is executed. Edge extraction processing is processing that utilizes density differences between pixels to extract line segments. Examples of widely used methods for edge extraction processing include using Sobel, Roberts and Prewitt filters. Note that binarization is preferably performed at step 132 in order to emphasize edges. Then at step 134 noise removal processing is executed. Portions other than wiring lines, such as components, for example LSIs, are removed by the noise removal processing. Separate data, such as for example residual imaging noise from when edge extraction was performed (i.e., good-for-nothing or garbage), is also removed by the noise removal processing. Examples of generally used methods for noise removal processing include processing employing a filter such as a median filter or averaging filter. Then line segment processing is performed at step 136. Line segment processing is processing to extract line segments contained in the image and is executed by, for example, processing with a “Hough transform” to extract straight lines. Line segment processing may also include processing to derive the coordinates of line segments.

When pre-processing is finished, at step 108 in FIG. 7, the image file generation section 24 acquires the data pallet. Namely, the image file generation section 24 extracts the data pallet corresponding to the image output elements of the category for image output designated at step 104 from the data pallet definition table 30 (FIG. 4) in the storage section 28.

Then for the single pixel designated at step 110, the image file generation section 24 embeds the pallet number at step 114 when the designated pixel corresponds to the image output element of the image output category (determination at step 112 is affirmative). Namely, when the designated pixel corresponds to the image output element, the embedding section 26 derives the pallet number for matching to the contents of the current data pallet from the attribute data corresponding to the pixel data. The embedding section 26 then embeds the derived pallet number in the definition data. Namely, the pallet number is embedded as definition data in the color pallet region corresponding to the 1 pixel image data. Thus data is produced containing attribute data associated with the image data, namely containing data such as the plan view profile and stacking direction (stacking layers), and logical data representing line prohibition and allowance, associated with each of the image output elements.

When the above pallet number embedding processing has been completed for all of the pixels (determination at step 116 is affirmative), the image file generation section 24 generates an image file of the image output elements.

When image file generation of the image output elements has been completed by the image file generation section 24 (determination at step 120 is affirmative), the integration build section 32 generates a CAD image file at step 122. Namely, the integration build section 32 sorts the image files for each of the image elements generated by the image file generation section 24 into each of the layers and generates CAD image files integrating the plural layers included in the circuit board.

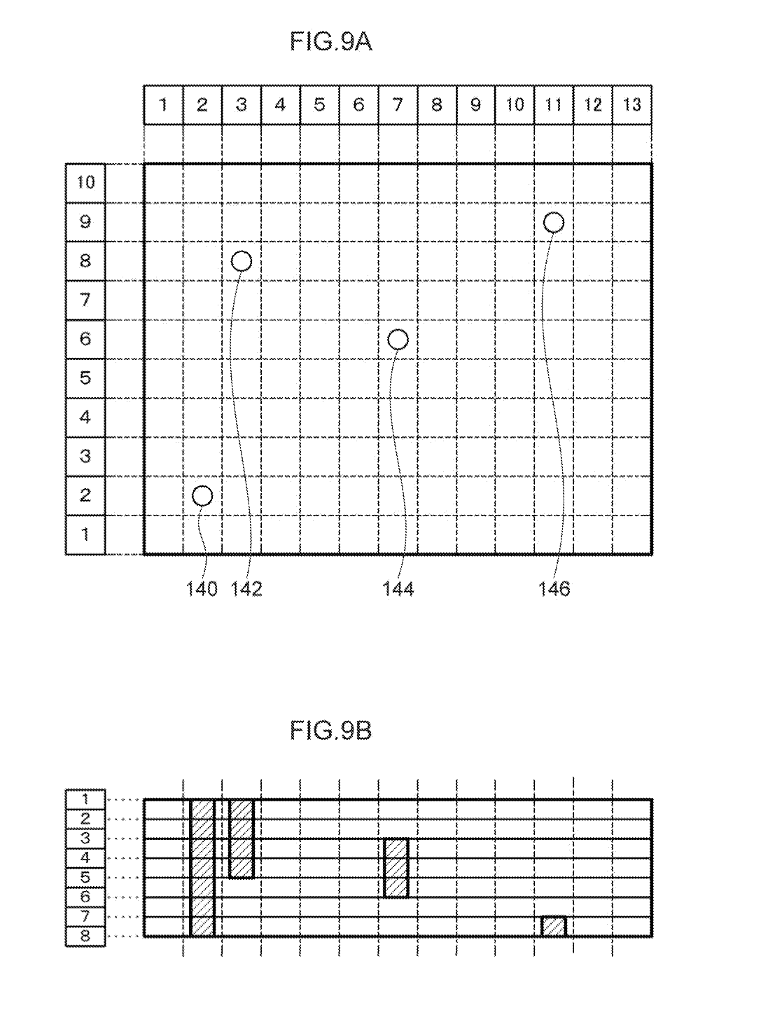

FIGS. 9A and 9B illustrate an example of an image output element, and illustrates vias representing interlayer connections in a multi-layer circuit board. FIG. 9A illustrates an image of VIA that is an image element in the first layer L1 for a circuit board of 8 layers (N=8). FIG. 9B is a diagram of the 8 layer circuit board illustrating the stacking direction (stacking layers). The via 140 illustrated in FIG. 9A connects from the first layer to the eighth layer. The via 140 accordingly corresponds to the pallet number “1” of the data pallet “VIA” in the data pallet definition table 30 (see also FIG. 4). Hence the pallet number “1” is embedded as definition data in the color pallet region of the image data corresponding to the pixel at the position of the via 140 (row 2, column 2 position in FIG. 9A). Similarly, the via 142 connects from the first layer to the fifth layer, and so the pallet number “2” (see also FIG. 4) is embedded as definition data in the color pallet region of the image data corresponding to the pixel at the row 8, column 3 position in FIG. 9A. The via 144 connects from the third layer to the sixth layer and so the pallet number “3” (see also FIG. 4) is embedded as definition data in the color pallet region of the image data corresponding to the pixel at the row 6, column 7 position in FIG. 9A. The via 146 is connected from the seventh layer to the eighth layer and so the pallet number “4” (see also FIG. 4) is embedded as definition data in the color pallet region of the image data corresponding to the pixel at the row 9, column 11 position in FIG. 9A.

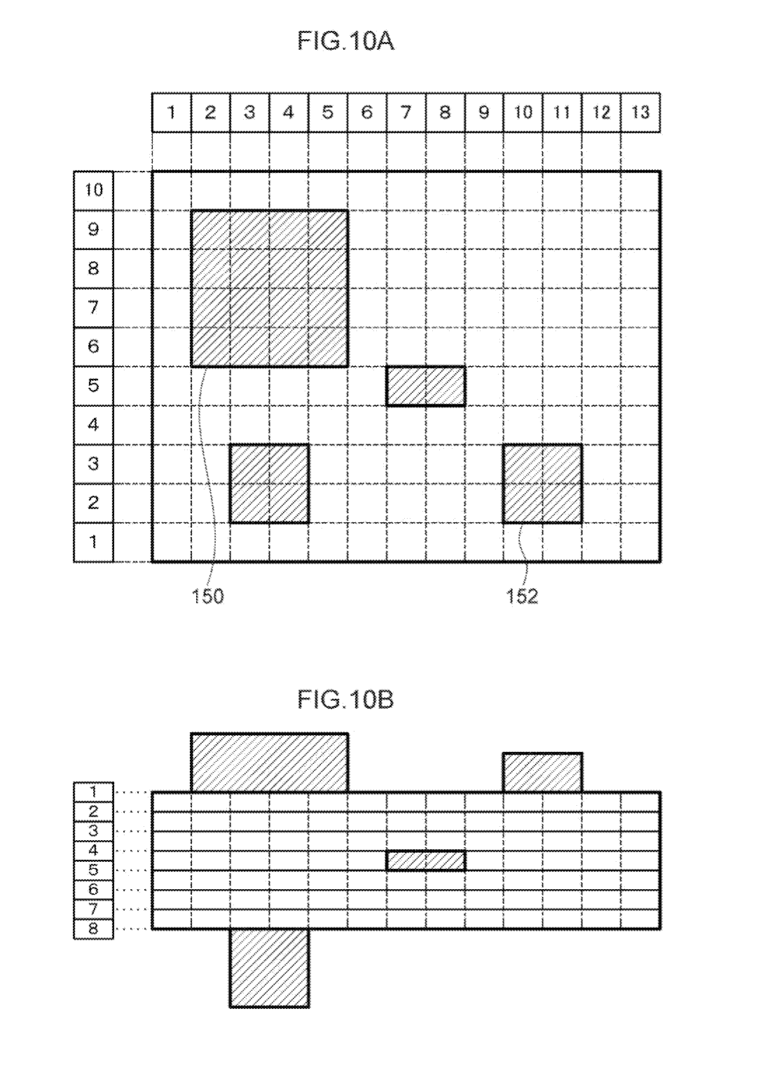

FIGS. 10A and 10B illustrate component height in a multi-layered circuit board as another example of image output elements. FIG. 10A illustrates an image of a component that is an image element in a first layer L1 for an 8 layer (N=8) circuit board. FIG. 10B is a diagram of the 8 layer circuit board illustrating the stacking direction (stacking layers). The component 150 is disposed in the first layer. Data related to the height of the component can be obtained from attribute data for the component 150. Consider a case where data representing a height of 0.3 mm is obtained. The component 150 therefore corresponds to the pallet number “2” (see also FIG. 4) of the data pallet “component height” in the data pallet definition table 30. Therefore the pallet number “2” is embedded as definition data in the color pallet region of the image data corresponding to pixels in the rectangular region from the position row 6, column 2 to the position row 9, column 5 in FIG. 10A, the placement position of the component 150. Similarly for data representing that the component 152 has a height of 0.25 mm, the pallet number “3” (see also FIG. 4) is embedded as definition data in the color pallet region of the image data corresponding to pixels in the rectangular region from the position row 2, column 10 to the position row 3, column 11 in FIG. 10A.

The above concludes processing in the image file generation apparatus 12. It is thereby possible to handle the CAD image file generated by the image file generation apparatus 12 as data containing attribute data associated with image data. Namely, it becomes possible to handle the data as data containing data such as the plan view profile and stacking direction (stacking layers), and logical data representing line prohibition and allowance, associated with the image data for each of the image output elements.

Explanation next follows regarding image file analysis processing executed by the image file analysis apparatus 14, with reference to FIG. 11. The processing routine illustrated in FIG. 11 is executed in the image file analysis processing. At step 200, a CAD image file for an image file analysis subject is acquired. Namely, a CAD image file is generated by the image file generation apparatus 12, and imported by the input section 34 of the image file analysis apparatus 14. Then at step 202 the input section 34 sorts the imported CAD image files into each of the layers of the stacked circuit board, and sorts into the image output elements that are the image output categories. Namely, for example for an N layered stacked circuit board, the input section 34 sorts into physical layers for each layer contained in CAD image files by sorting into a first layer L1 to an N^{th} layer LN. Then, the input section 34 sorts into logic layers for each of the layers (for example the image output elements included in the first logic layer).

Then, at step 204 the image analysis section 36 designates the image output element that is the image output category, and acquires the data pallet thereof at step 206. Namely, for example for the N layer stacked circuit board, the image analysis section 36 designates the physical layers of each of the layers contained in the CAD image file in sequence. The logic layers that are the image output elements contained in the designated layer (starting at the first physical layer) are then also designated in sequence.

Then at step 206, the image analysis section 36 acquires the data pallet corresponding to the image output element that is the image output category designated at step 204. Namely, the image analysis section 36 extracts the data pallet corresponding to the image output element of the image output category designated at step 204 from the data pallet definition table 40 of the storage section 38 (see FIG. 3).

The image analysis section 36 then designates 1 pixel at step 208, and when the designated pixel corresponds to the image output element of the image output category (determination at step 210 is affirmative), the image analysis section 36 extracts the definition data from the image file at step 212. Namely, when the designated pixel corresponds to the image output element, the image analysis section 36 extracts the data stored in the color pallet region corresponding to the pixel data, namely the pallet number. The image analysis section 36 then extracts the contents corresponding to the extracted pallet number. The contents of the extracted pallet number are attribute data associated with image data of the image output element.

The image analysis section 36 then converts the attribute data associated with the image data of the image file of the image output element, for example into text data, and generates image file analysis data of an image file and text data and stores the generated data in a memory. It is thereby possible to handle data such as the plan view profile and stacking direction (stacking layers), and logical data representing line prohibition and allowance, associated with image data of image output elements, for example as text data. Then when complete for all the pixels (determination at step 214 is affirmative), at step 216 the image analysis section 36 generates image file analysis data of image output elements. Then when analysis has been completed for all the image output elements (determination at step 218 is affirmative), the image analysis section 36 stores the image file analysis data for all of the image output elements in a memory, for the current layer. The above processing is executed for all of the layers. Analysis of the imported CAD image file is thereby completed. The attribute data associated with the image data from CAD image files is accordingly extracted, for example as text data. The data associated with image data for each of the image output elements, such as the plan view profile and stacking direction (stacking layers) and the logical data representing line prohibition and allowance is accordingly capable of being handled, for example as text data.

When the image file analysis data has been generated for all of the layers, the difference construction section 42 of the image file analysis apparatus 14 derives differences to a base CAD image file 48. Differences are derived here between the CAD image file analyzed by the image analysis section 36 and a base CAD image file 48 stored in the database 46 that has been designated by the designation section 44. Namely, the difference construction section 42 acquires the base CAD image file at step 220. The base CAD image file is a file acquired from the base CAD image file 48 stored in the database 46 and corresponds to the analyzed CAD image file. Namely, the base CAD image file 48 stored in the database 46 is input to the difference construction section 42 by the designation section 44.

Processing proceeds to step 226 when the base CAD image files are files of image file and text data that have finished being analyzed as image file analysis data (determination at step 222 is affirmative). However, when negative determination is made, then at step 224, similar processing is executed on the base CAD image file to the processing of step 202 to step 218.

The difference construction section 42 derives the differences between the CAD image file analyzed by the image analysis section 36 and the base CAD image file 48 stored in the database 46 designated by the designation section 44. Namely, the difference construction section 42 is able to derive the differences in attribute data for each of the image output elements by comparing the text data of the CAD image file analyzed by the image analysis section 36 against the text data of the base CAD image file 48. The difference construction section 42 constructs the difference data associated with each of the layers of the circuit board from data representing the differences in each of the image output elements. The difference construction section 42 is thereby able to derive difference data for image data between the image file in the CAD image file analyzed by the image analysis section 36 and the image file in the base CAD image file 48.

After deriving the difference between the CAD image file and the base CAD image file, the difference construction section 42 then displays data representing the derived differences at step 228. The data representing the differences contains data for displaying differences in the text data and data for displaying differences in the image data. Note that the data representing the derived differences is not limited to data for display, and the difference construction section 42 may be configured to output such derived differences as data.

An example has been explained above in which the image file generation apparatus and the image file analysis apparatus are both implemented by computer. However, there is no limitation to these configurations and obviously various improvements and modifications may be implemented within a range not departing from the spirit explained above.

Note also that while an exemplary embodiment has been explained above in which programs are pre-stored (installed) there is no limitation thereto. For example, the image file generation program and/or the image file analysis program of the technology disclosed herein may be provided in a format stored on a storage medium such as a CD-ROM or a DVD-ROM.

Moreover, although an exemplary embodiment has been described above in which a circuit board such as a printed circuit board is the design object, the design object is not limited to a circuit board. For example, any design object may be employed in which data for use in design values of design elements is shared.

An aspect exhibits the advantageous effect of enabling generation of data with extractable points of difference between plural common sets of data.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

All cited documents, patent applications and technical standards mentioned in the present specification are incorporated by reference in the present specification to the same extent as if the cited documents, patent applications and technical standards were specifically and individually incorporated by reference in the present specification.

What is claimed is:

1. An image file processing apparatus comprising:
a processor;
a memory; and
a image file generation apparatus, wherein
the memory stores instructions, and when the instructions are executed by the processor, the image file generation apparatus performs a first procedure, the first procedure including:
(a) storing, in the memory, a table in which identifiers for identifying data representing design values of design elements are associated with data representing design values of design elements of a design object for each of the design elements of the design object;
(b) acquiring image generation data for each of the design elements of the design object based on design data of the design object containing design values of the respective design elements; and
(c) generating image data expressing an image for each of the design elements of the design object based on the image generation data acquired at (b), deriving the identifiers corresponding to design values of the design elements for the generated image data based on the table stored in the memory, associating the derived identifiers with the generated image data, and, for each of the design elements of the design object, generating an image file containing the image data and definition data related to the image data.

2. The image file processing apparatus of claim 1, wherein
the image file contains the image data and definition data related to the image data color, and
(c) includes embedding the derived identifiers in the definition data.

3. The image file processing apparatus of claim 1, wherein
the design object is a circuit board, and
(c) includes taking a size of a pre-designated component from among design elements of the circuit board as a unit size for defining an image divided vertically and horizontally into plural partitions with the size of 1 pixel set at the unit size, and generating image data for a plurality of partitioned pixels.

4. The image file processing apparatus of claim 1, wherein
the design object is a circuit board, and
(c) includes amalgamating generated image files of plural design elements of the circuit board to build a circuit board image file.

5. The image file processing apparatus of claim 1, wherein
the design object is a circuit board, and
the memory contains as the table a definition table including identifiers for identifying data representing design values as data pallets associated with data representing design values for each of the design elements of the circuit board.

6. The image file processing apparatus of claim 1 further comprising an image analysis apparatus, wherein
the memory stores instructions, and when the instructions are executed by the processor, the image analysis apparatus performs a second procedure, the second procedure including:
(d) for each of the design elements of the design object, storing, in the memory, a table in which identifiers for identifying data representing design values of design elements is associated with data representing design values of design elements of a design object;
(e) inputting an image file generated by the image file generation apparatus; and
(f) deriving image forming data for forming an image based on the image file that has been input at (e), deriving data representing design values of the design elements indicated by the identifiers corresponding to the image data based on the table stored in the memory, and outputting the derived image forming data and the data representing the design values of the design elements.

7. The image file processing apparatus of claim 6, wherein the second procedure further includes:
(g) designating a base image file containing image data of design elements of the design object and definition data that is related to the image data and that contains the identifiers corresponding to design values of the design elements for the image data; and
(h) deriving difference data of difference data from comparison of image forming data from (f) against image data of the base image file designated at (g), or difference data from comparison of data representing design values of the design elements from (f) against data representing design values of the design elements of the base image file designated at (g), or a combination thereof, and outputting the derived difference data.

8. An image file processing method comprising:
an image file generation method including:
(a) acquiring image generation data for each of design elements of a design object based on design data of the design object containing design values of the respective design elements; and
(b) by a processor, generating image data expressing an image for each of the design elements of the design object based on the image generation data acquired at (a), deriving identifiers corresponding to design values of the design elements for the generated image data based on a table in which identifiers for identifying data representing design values of design elements are associated with data representing design values of design elements of a design object stored for each of the design elements of the design object in a memory, and associating the derived identifiers with the generated data to generate an image file, for each of the design elements of the design object, containing the image data and definition data related to the image data.

9. The image file processing method of claim 8, wherein
the design object is a circuit board, and
the memory contains as the table a definition table including identifiers for identifying data representing design values as data pallets associated with data representing design values for each of the design elements of the circuit board.

10. The image file processing method of claim 8, wherein
the image file contains the image data and definition data related to the color of the image data, and
(b) includes embedding the derived identifier in the definition data.

11. The image file processing method of claim 8, wherein
the design object is a circuit board, and
(b) includes taking a size of a pre-designated component from among design elements of the circuit board as a unit size for defining an image divided vertically and horizontally into plural partitions with the size of 1 pixel set at the unit size, and generating image data for a plurality of partitioned pixels.

12. The image file processing method of claim 8, wherein
the design object is a circuit board, and
(b) includes amalgamating generated image files of plural design elements of the circuit board to build a circuit board image file.

13. The image file processing method of claim 8 further comprising an image file analysis method including:
(c) inputting an image file generated by the image file generation method; and
(d) by the processor, deriving image forming data for forming an image based on the image file input at (c), deriving data representing design values of design elements indicated by identifiers corresponding to the image data based on a table in which identifiers for identifying data representing design values of design elements are associated with data representing design values of the design elements of the design object stored for each of the design elements of a design object in the memory, and outputting the derived image forming data and data representing the design values of the design elements.

14. The image file processing method of claim 13, wherein
the image file analysis method further includes:
(e) designating a base image file containing image data of design elements of the design object and definition data that is related to the image data and that contains the identifiers corresponding to design values of the design elements for the image data; and
(f) by the processor, deriving difference data of difference data from comparison of image forming data from (d) against image data of the base image file designated at (e), or difference data from comparison of data representing design values of the design elements from (d) against data representing design values of the design elements of the base image file designated at (e), or a combination thereof, and outputting the derived difference data.

15. A computer-readable recording medium having stored therein a program for causing a computer to execute an image file processing process comprising an image file generation process including:
(a) acquiring image generation data for each of design elements of a design object based on design data of the design object containing design values of the respective design elements; and
(b) generating image data expressing an image for each of the design elements of the design object based on the image generation data acquired at (a), deriving identifiers corresponding to design values of the design elements for the generated image data based on a table in which identifiers for identifying data representing design values of design elements are associated with data representing design values of design elements of a design object stored for each of the design elements of the design object in a memory, and associating the derived identifiers with the generated data to generate an image file for each of the design elements of the design object, containing the image data and definition data related to the image data.

16. The computer-readable recording medium of claim 15, wherein the image file processing process further comprises a image file analysis process including:
(c) inputting an image file generated by the image file generation process; and
(d) deriving image forming data for forming an image based on the image file input at (c), deriving data representing design values of design elements indicated by identifiers corresponding to the image data based on a table stored in the memory for each of the design elements of a design object in which identifiers for identifying data representing design values of design elements have been associated with data representing design values of the design elements of the design object, and outputting the derived image forming data and data representing the design values of the design elements.

17. The computer-readable recording medium of claim 16, wherein
the image file analysis process further includes:
(e) designating a base image file containing image data of design elements of the design object and definition data that is related to the image data and that contains the identifiers corresponding to design values of the design elements for the image data; and
(f) deriving difference data of difference data from comparison of image forming data from (d) against image data of the base image file designated at (e), or difference data from comparison of data representing design values of the design elements from (d) against data representing design values of the design elements of the base image file designated at (e), or a combination thereof, and outputting the derived difference data.
